(19) United States
(12) Patent Application Publication
(10) Pub. No.: US 2024/0425627 A1
(43) Pub. Date: Dec. 26, 2024

(54) HDPE INTERMEDIATE BULK CONTAINER RESIN USING ADVANCED CHROME CATALYST BY POLYETHYLENE GAS PHASE TECHNOLOGY

(71) Applicant: Univation Technologies, LLC, Houston, TX (US)

(72) Inventors: Elva L. Lugo, Lake Jackson, TX (US); Mengmeng Li, Lake Jackson, TX (US); Cliff R. Mure, Hillsborough, NJ (US); Taylor L. Crammer, Charleston, WV (US); Francois Alexandre, Quebec (CA)

(73) Assignee: Univation Technologies, LLC, Houston, TX (US)

(21) Appl. No.: 18/700,450

(22) PCT Filed: Oct. 14, 2022
(86) PCT No.: PCT/US2022/078144

§ 371 Date: Apr. 11, 2024

Related U.S. Application Data
(60) Provisional application No. 63/256,319, filed on Oct. 15, 2021.

(51) Int. Cl. C08F 210/16; B29C 49/00; B29C 49/04; B29K 23/00; C08F 2/34; C08F 4/69

(52) U.S. Cl. CPC C08F 210/16; B29C 49/0005; B29C 49/04; C08F 2/34; C08F 4/69; B29K 2023/08

(57) ABSTRACT

According to one embodiment, a process for producing unimodal ethylene/α-olefin copolymer, the process comprising contacting ethylene and, optionally, one or more (C₃-C₁₂)α-olefin comonomers with a catalyst system in a gas-phase polymerization reactor, wherein the catalyst system comprises a chromium-based catalyst; wherein the unimodal ethylene copolymer comprises: a density from 0.942 g/cm³ to 0.950 g/cm³ according to ASTM D792-13; a flow index (I₂₁) from 5.5 to 7.5 dg/min, when measured according to ASTM D1238 at 190° C. and a 21.6 kg load; a strain hardening modulus of 40 to 50 MPa; and a molecular weight distribution (MWD) as determined by a conventional gel permeation chromatography method or absolute gel permeation chromatography.

### CROSS-REFERENCE TO RELATED APPLICATION

This application claims the benefit of and priority to U.S. Application Ser. No. 63/256,319 filed on Oct. 15, 2021, and entitled “HDPE INTERMEDIATE BULK CONTAINERS RESIN USING ADVANCED CHROME CATALYST BY POLYETHYLENE GAS PHASE TECHNOLOGY,” the entire contents of which are incorporated by reference in the present disclosure.

### TECHNICAL FIELD

Embodiments of the present disclosure generally relate to high-density polyethylene (HDPE) resins; the processes to produce the resins, in which the processes include gas phase polymerization reaction; and the articles produced from the HDPE resins.

### BACKGROUND

Intermediate bulk containers (IBC) are a type of container that are generally between 275-330 gallons in volume. They are designed primarily for the efficient transport of high value or hazardous materials, e.g., cosmetics, pharmaceuticals, and semi-conductor and electronics chemicals, and are intended for multiple use. Owing to the high value or hazardous nature of their contents, IBC are required to meet UN/DOT specifications. In order to meet these UN/DOT specifications the PE resin compositions used must meet key performance requirements including melt strength, toughness, and stiffness.

Industry standards for large containers (e.g., drums or intermediate bulk containers (IBCs)) composed of polyethylene resins require robust end-use performance, including top-load strength, stiffness, toughness, impact strength, and environmental stress crack resistance (ESCR). The containers are manufactured by a blow-molding process which requires the resins to have good processability, melt strength, parison thickness, and diameter swell.

Due to the manufacturing design and the industry standards, balancing manufacturing processability with end-use performance results is challenging. For example, improving a resin's properties to enhance its processability may result in weaker end-use performance of the blow molded containers. On the other hand, improving the resin's properties to enhance the containers' end-use performance can deteriorate the resin's processability. To avoid a situation where either the industry standards for containers are not met, the containers cannot be manufactured, or both, a polyethylene resin grade for containers must have a proper balance of these competing properties.

Improving end-performance of containers while enabling processability is challenging and not predictable ahead of time due to unknowable variables. Such unknowable variables include different polymerization catalysts inherently produce different resins with different combinations of properties, different gas phase polymerization process conditions inherently produce different combinations of resin properties, and different fundamental types of polyethylene resins (such as unimodal versus bimodal, higher density versus lower density) inherently produce different combinations of properties. For example, bimodal polyethylene compositions include a HMW component and a LMW component with reversed short chain branch distribution (SCBD). These bimodal resins may improve top-load strength, stiffness, toughness, impact strength, and environmental stress crack resistance (ESCR). However, they often lack the blow molding processability, melt strength and parison thickness and diameter swell needed during fabrication.

A resin that delivers satisfactory properties, but is considered too difficult to process will struggle commercially. Processability of blow molded resins is related to the shape of the parison, or the extruded molten polymer after it leaves the die and before the molds close. The parison shape may be important for proper bottle formation and processing and is subject to change in the time period between die exit and closure of the molds. The parison shape can be impacted by swell, gravity, also referred to as sag, and geometry of the die and mandrel tooling. Swell is the result of the relaxation of the polymer melt upon exiting the die (elastic recovery of stored energy in the melt). On a laboratory scale, swell tests are performed in order to predict the shape of the parison. Unfortunately, there is not an absolute swell test beyond running the resin on the intended blow molding machine.

Another important balance for blow molded resins is between stiffness and toughness. These two attributes are inversely related and depend on the resin's density. All other things being equal, a higher density resin will deliver higher stiffness, but lower ESCR. Alternatively, a lower density resin will deliver lower stiffness and higher ESCR.

### SUMMARY

Accordingly, there may be a continual need for polyethylene compositions having good melt strength, toughness, and stiffness, as well as good processability.

Unimodal polyethylene polymers produced from a chromium-based catalyst system have good processability and polymer melt strength, typically due to their broad molecular weight distribution (MWD), but their containers often lack the toughness, impact strength, and environmental stress crack resistance (ESCR).

The resin of this disclosure seeks to offers both excellent ESCR, impact strength, and stiffness such that the large part can be light-weighted. When comparing two resins, an increased ESCR, despite a lower M_{z}/M_{w} ratio, would be unpredictable.

Ongoing needs exist to create a polymer resin having good melt strength, toughness, and stiffness, as well as good processability. Embodiments of this disclosure include unimodal ethylene/α-olefin copolymer comprising polymerized units derived from ethylene.

Embodiments of this disclose includes a process for producing unimodal ethylene/α-olefin copolymer. The process includes contacting ethylene and, optionally, one or more (C₃-C₁₂)α-olefin comonomers with a catalyst system in a gas-phase polymerization reactor. The catalyst system comprises a chromium-based catalyst; and the unimodal ethylene copolymer comprises: a density from 0.942 g/cm³ to 0.950 g/cm³ according to ASTM D792-13; a flow index (I₂₁) from 5.5 to 7.5 dg/min, when measured according to ASTM D1238 at 190° C. and a 21.6 kg load; a strain hardening modulus of 40 to 50 MPa; and a molecular weight distribution (MWD), as calculated by dividing the weight average molecular weight (Mw) by the molecular number (Mn) (M_{w}/Mₙ), wherein M_{w} and Mₙ are measured by a conventional gel permeation chromatography method (GPC_{conv}) or by an absolute gel permeation chromatography method (GPC_{abs}). The M_{w}/Mₙ may be from 27 to 33 as determined by a conventional gel permeation chromatography method (GPC_{conv}). Alternatively, the M_{w}/Mₙ may be from 24 to 29 as determined by the absolute gel permeation chromatography method (GPC_{abs}).

Embodiments includes unimodal ethylene/α-olefin copolymers that include polymerized units derived from ethylene, wherein the unimodal ethylene/α-olefin copolymer comprises: a density from 0.942 g/cm³ to 0.950 g/cm³ according to ASTM D792-13; a flow index (I₂₁) from 5.5 to 7.5 dg/min, when measured according to ASTM D1238 at 190° C. and a 21.6 kg load; Charpy impact strength of 6.5 to 8.5 kilojoules per meter square (kJ/m²), measured at −40 C according to ISO 179; a stain hardening modulus of 41 to 45 MPa; and a molecular weight distribution (MWD), as measured by the weight average molecular weight (Mw) divided by the molecular number (Mn) (M_{w}/Mₙ). The M_{w}/Mₙ may be from 27 to 33 as determined by the conventional gel permeation chromatography method (GPC_{conv}). Alternatively, the M_{w}/Mₙ may be from 24 to 29 as determined by the absolute gel permeation chromatography method (GPC_{abs}).

### DETAILED DESCRIPTION

The terms “ethylene/α-olefin polymer” or “polyethylene polymer” as used herein, refer to a polymer made of 100% ethylene-monomer units (a homopolymer) or refers to copolymers produced with other monomeric moieties, such as α-olefins (including, but not limited to, propylene, 1-butene, 1-pentene, 1-hexene, 1-octene, and so forth), wherein the copolymer comprises greater than 50% of its units from ethylene. Various polyethylene polymers are contemplated as suitable. For example and not by way of limitation, the polyethylene polymer may comprise HDPE.

In one or more embodiments of the present disclosure, the multimodal HDPE may be a unimodal HDPE. The term “unimodal” refers a MWD in a GPC curve that exhibits a single component in the polymer resin.

Unless otherwise indicated values and ranges for molecular weights M_{w}, Mₙ, M_{z}, and Mₚ and values and ranges for MWD (M_{w}/Mₙ) have been measured according to the conventional GPC method described later (“GPC_{conv}”). Values and ranges for molecular weights M_{w}, Mₙ, M_{z}, and Mₚ and values and ranges for MWD (M_{w}/Mₙ) that are marked with “GPC_{abs}” or are said to be absolute GPC values and ranges have been measured by the absolute GPC method described later. Where there is a choice between using GPC_{conv} values and ranges and GPC_{abs} values and ranges to describe inventive embodiments, the GPC_{abs} values and ranges are preferred. Where this a question of accuracy, especially for M_{w} and M_{z}, the GPC_{abs} values control.

### Polymerization Process

One or more embodiments of disclosure include a process for producing a unimodal ethylene/α-olefin copolymer. The process includes contacting ethylene and, optionally, one or more (C₃-C₁₂)α-olefin comonomers with a chromium-based catalyst system in a gas-phase polymerization reactor. The unimodal ethylene/α-olefin copolymer comprising polymerized units derived from ethylene. The unimodal ethylene/α-olefin copolymer includes a density from 0.942 g/cm³ to 0.950 g/cm³ according to ASTM D792-13; a flow index (I₂₁) from 5.5 to 7.5 dg/min, when measured according to ASTM D1238 at 190° C. and a 21.6 kg load; a negative 40° C. Charpy impact strength of 6.5 to 8.5 kilojoules per meter square (kJ/m²), measured at −40 C according to ISO 179; a stain hardening modulus of 41 to 45 MPa; and a molecular weight distribution (MWD) is from 27 to 33 as determined by a conventional gel permeation chromatography method.

In some embodiments the unimodal ethylene/α-olefin copolymer has a melt index (I₂) less than 0.15 g/10 min. measured at 190° C. and 2.16 kg according to ASTM D1238-13. Without being bound by theory, it is believed that a melt index (I₂) less than 0.15 g/10 min. is below the minimum value that may be reliably measured by ASTM D1238-13. This feature can distinguish the inventive unimodal ethylene/α-olefin copolymer from non-inventive unimodal ethylene/α-olefin copolymers that have a melt index (I₂) of greater than 0.15 g/10 min.

### Chromium-Based Catalysts System

In one or more embodiments, the chromium-based catalyst system may include chromium-based catalyst and a reducing agent.

In some embodiments, the chromium-based catalysts may include chromium oxide catalysts, silyl chromate catalysts, or a combination of both chromium oxide and silyl chromate catalysts.

The chromium compounds used to prepare chromium oxide catalysts may include CrO₃ or any compound convertible to CrO₃ under the activation conditions employed. Compounds capable of being converted into to CrO₃ include chromic acetyl acetonate, chromic halide, chromic nitrate, chromic acetate, chromic sulfate, ammonium chromate, ammonium dichromate, or other soluble, chromium containing salts. In some embodiments, chromic acetate may be used.

In one or more embodiments, the reducing agent may comprise at least one of an alkylaluminum and an alkyl aluminum alkoxide. In some embodiments the reducing agent is the alkylaluminum, such as a trialkylaluminum

The process for making the chromium-based catalyst system is discloses in International Published Application WO 2009/108174, which is incorporated herein in its entirety.

The inorganic oxide materials which may be used as a support in the catalyst compositions of the present disclosure are porous materials having variable surface area and particle size. In some embodiments, the support may have a surface area in the range of 50 to 1000 square meters per gram, and an average particle size of 20 to 300 micrometers. In some embodiments, the support may have a pore volume of about 0.5 to about 6.0 cm3/g and a surface area of about 200 to about 600 m2/g. In other embodiments, the support may have a pore volume of about 1.1 to about 1.8 cm3/g and a surface area of about 245 to about 375 m2/g. In some other embodiments, the support may have a pore volume of about 2.4 to about 3.7 cm3/g and a surface area of about 410 to about 620 m2/g. In yet other embodiments, the support may have a pore volume of about 0.9 to about 1.4 cm3/g and a surface area of about 390 to about 590 m2/g. Each of the above properties may be measured using conventional techniques as known in the art.

Activation of the supported chromium oxide catalyst can be accomplished at nearly any temperature from about 300° C. up to the temperature at which substantial sintering of the support takes place. For example, activated catalysts may be prepared in a fluidized bed, as follows. The passage of a stream of dry air or oxygen through the supported chromium-based catalyst during the activation aids in the displacement of any water from the support and converts, at least partially, chromium species to Cr+6.

Temperatures used to activate the chromium-based catalysts are often high enough to allow rearrangement of the chromium compound on the support material. Peak activation temperatures of from about 300 to about 900° C. for periods of from greater than 1 hour to as high as 48 hours are acceptable. In some embodiments, the supported chromium oxide catalysts are activated at temperatures from about 400 to about 850° C., from about 500 to about 700° C., and from about 550 to about 650° C. Exemplary activation temperatures are about 600° C., about 700° C., and about 800° C. Selection of an activation temperature may take into account the temperature constraints of the activation equipment. In some embodiments, the supported chromium oxide catalysts are activated at a chosen peak activation temperature for a period of from about 1 to about 36 hours, from about 3 to about 24 hours, and from about 4 to about 6 hours. Exemplary peak activation times are about 4 hours and about 6 hours. Activation is typically carried out in an oxidative environment; for example, well dried air or oxygen is used and the temperature is maintained below the temperature at which substantial sintering of the support occurs. After the chromium compounds are activated, a powdery, free-flowing particulate chromium oxide catalyst is produced.

The cooled, activated chromium oxide catalyst may then be slurried and contacted with a reducing agent, fed at a selected feed rate over a selected time period, to result in a catalyst composition having a flow index response within a selected range. The solvent may then be substantially removed from the slurry to result in a dried, free-flowing catalyst powder, which may be fed to a polymerization system as is or slurried in a suitable liquid prior to feeding.

As noted above, the catalyst systems of the present disclosure may be utilized in processes for producing polymers, such as polyethylene, via the polymerization of olefins, such as ethylene. In embodiments, one or more olefins may be contacted with the catalyst systems of the present disclosure in a gas-phase polymerization reactor, such as a gas-phase fluidized bed polymerization reactor. Exemplary gas-phase systems are described in U.S. Pat. Nos. 5,665,818; 5,677,375; and 6,472,484; and European Patent Nos. 0 517 868 and 0 794 200. For example, in some embodiments, ethylene and, optionally, one or more (C₃-C₁₂)α-olefin comonomers may be contacted with the catalyst systems of the present disclosure in a gas-phase polymerization reactor. The catalyst system may be fed to the gas-phase polymerization reactor in neat form (i.e., as a dry solid), as a solution, or as a slurry. In another example, the chromium-based catalyst may be fed into the reactor and the reducing agent may be added over a time period ranging from 5 seconds to greater than 5 second.

In embodiments, the gas-phase polymerization reactor comprises a fluidized bed reactor. A fluidized bed reactor may include a “reaction zone” and a “velocity reduction zone.” The reaction zone may include a bed of growing polymer particles, formed polymer particles, and a minor amount of the catalyst system fluidized by the continuous flow of the gaseous monomer and diluent to remove heat of polymerization through the reaction zone. Optionally, some of the re-circulated gases may be cooled and compressed to form liquids that increase the heat removal capacity of the circulating gas stream when readmitted to the reaction zone. A suitable rate of gas flow may be readily determined by simple experiment. Make up of gaseous monomer to the circulating gas stream may be at a rate equal to the rate at which particulate polymer product and monomer associated therewith may be withdrawn from the reactor and the composition of the gas passing through the reactor may be adjusted to maintain an essentially steady state gaseous composition within the reaction zone. The gas leaving the reaction zone may be passed to the velocity reduction zone where entrained particles are removed. Finer entrained particles and dust may be removed in a cyclone and/or fine filter. The gas may be passed through a heat exchanger where the heat of polymerization may be removed, compressed in a compressor, and then returned to the reaction zone. Additional reactor details and means for operating the reactor are described in, for example, U.S. Pat. Nos. 3,709,853; 4,003,712; 4,011,382; 4,302,566; 4,543,399; 4,882,400; 5,352,749; and 5,541,270; European Patent No. 0 802 202; and Belgian Patent No. 839,380.

In embodiments, the reactor temperature of the gas-phase polymerization reactor is from 30° C. to 150° C. For example, the reactor temperature of the gas-phase polymerization reactor may be from 30° C. to 120° C., from 30° C. to 110° C., from 30° C. to 100° C., from 30° C. to 90° C., from 30° C. to 50° C., from 30° C. to 40° C., from 40° C. to 150° C., from 40° C. to 120° C., from 40° C. to 110° C., from 40° C. to 100° C., from 40° C. to 90° C., from 40° C. to 50° C., from 50° C. to 150° C., from 50° C. to 120° C., from 50° C. to 110° C., from 50° C. to 100° C., from 50° C. to 90° C., from 90° C. to 150° C., from 90° C. to 120° C., from 90° C. to 110° C., from 90° C. to 100° C., from 100° C. to 150° C., from 100° C. to 120° C., from 100° C. to 110° C., from 110° C. to 150° C., from 110° C. to 120° C., or from 120° C. to 150° C. Generally, the gas-phase polymerization reactor may be operated at the highest temperature feasible, taking into account the sintering temperature of the polymer product within the reactor. Regardless of the process used to make the polyethylene, the reactor temperature should be below the melting or “sintering” temperature of the polymer product. As a result, the upper temperature limit may be the melting temperature of the polymer product.

In embodiments, the reactor pressure of the gas-phase polymerization reactor is from 690 kPa (100 psig) to 3,448 kPa (500 psig). For example, the reactor pressure of the gas-phase polymerization reactor may be from 690 kPa (100 psig) to 2,759 kPa (400 psig), from 690 kPa (100 psig) to 2,414 kPa (350 psig), from 690 kPa (100 psig) to 1,724 kPa (250 psig), from 690 kPa (100 psig) to 1,379 kPa (200 psig), from 1,379 kPa (200 psig) to 3,448 kPa (500 psig), from 1,379 kPa (200 psig) to 2,759 kPa (400 psig), from 1,379 kPa (200 psig) to 2,414 kPa (350 psig), from 1,379 kPa (200 psig) to 1,724 kPa (250 psig), from 1,724 kPa (250 psig) to 3,448 kPa (500 psig), from 1,724 kPa (250 psig) to 2,759 kPa (400 psig), from 1,724 kPa (250 psig) to 2,414 kPa (350 psig), from 2,414 kPa (350 psig) to 3,448 kPa (500 psig), from 2,414 kPa (350 psig) to 2,759 kPa (400 psig), or from 2,759 kPa (400 psig) to 3,448 kPa (500 psig).

In embodiments, hydrogen gas may be used in during polymerization to control the final properties of the polyethylene. The amount of hydrogen in the polymerization may be expressed as a mole ratio relative to the total polymerizable monomer, such as, for example, ethylene or a blend of ethylene and 1-hexene. The amount of hydrogen used in the polymerization process may be an amount necessary to achieve the desired properties of the polyethylene, such as, for example, melt flow rate (MFR). In embodiments, the mole ratio of hydrogen to total polymerizable monomer (H₂:monomer) is greater than 0.0001. For example, the mole ratio of hydrogen to total polymerizable monomer (H₂:monomer) may be from 0.0001 to 10, from 0.0001 to 5, from 0.0001 to 3, from 0.0001 to 0.10, from 0.0001 to 0.001, from 0.0001 to 0.0005, from 0.0005 to 10, from 0.0005 to 5, from 0.0005 to 3, from 0.0005 to 0.10, from 0.0005 to 0.001, from 0.001 to 10, from 0.001 to 5, from 0.001 to 3, from 0.001 to 0.10, from 0.10 to 10, from 0.10 to 5, from 0.10 to 3, from 3 to 10, from 3 to 5, or from 5 to 10.

In embodiments, the catalyst systems of the present disclosure may be utilized to polymerize a single type of olefin, producing a homopolymer. However, additional α-olefins may be incorporated into the polymerization scheme in other embodiments. The additional α-olefin comonomers typically have no more than 20 carbon atoms. For example, the catalyst systems of the present disclosure may be utilized to polymerize ethylene and one or more (C₃-C₁₂)α-olefin comonomers. Exemplary α-olefin comonomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1-hexene, and 1-octene; or, in the alternative, from the group consisting of 1-hexene and 1-octene.

In embodiments, the one or more (C₃-C₁₂)α-olefin comonomers may not be derived from propylene. That is, the one or more (C₃-C₁₂)α-olefin comonomers may be substantially free of propylene. The term “substantially free” of a compound means the material or mixture includes less than 1.0 wt. % of the compound. For example, the one or more (C₃-C₁₂)α-olefin comonomers, which may be substantially free of propylene, may include less than 1.0 wt. % propylene, such as less than 0.8 wt. % propylene, less than 0.6 wt. % propylene, less than 0.4 wt. % propylene, or less than 0.2 wt. % propylene.

### Unimodal Ethylene/α-olefin Copolymer

In one or more embodiments of this disclosure, an unimodal ethylene/α-olefin copolymer comprising polymerized units derived from ethylene. The unimodal ethylene/α-olefin copolymer includes a density from 0.942 g/cm³ to 0.950 g/cm³ according to ASTM D792-13; a flow index (I₂₁) from 5.5 to 7.5 dg/min, when measured according to ASTM D1238 at 190° C. and a 21.6 kg load; Charpy impact strength of 6.5 to 8.5 kilojoules per meter square (kJ/m²), measured at negative 40 C according to ISO 179; a stain hardening modulus of 41 to 45 MPa; and a molecular weight distribution (MWD) is from 27 to 33 as determined by a conventional gel permeation chromatography method.

In some embodiments, the unimodal ethylene/α-olefin copolymer has a density is in the range of 0.943-0.949 g/cm³; 0.944-0.949 g/cm³, or 0.945-0.947 g/cm³.

In various embodiments, the unimodal ethylene/α-olefin copolymer has a melt flow index (I₂₁) is from 5.5 to 7.2 dg/min; 6.0 to 7.0 dg/min; or 6.3 to 7.0 dg/min.

In one or more embodiments, the unimodal ethylene/α-olefin copolymer has a melt viscosity ratio (V_{0.1}/V₁₀₀) at 190° C. is from 50 to 70, 55 to 65, or 55 to 60, where V_{0.1} is the viscosity of the unimodal ethylene/α-olefin copolymer at 190° C. at a frequency of 0.1 radians/second, and V₁₀₀ is the viscosity of the unimodal ethylene/α-olefin copolymer at 190° C. at a frequency of 100 radians/second.

The “rheology ratio” and “melt viscosity ratio” are defined by V_{0.1}/V₁₀₀ at 190° C., where V_{0.1} is the viscosity of the unimodal ethylene/α-olefin copolymer at 190° C. at an frequency of 0.1 radians/second, and V₁₀₀ is the viscosity of the unimodal ethylene/α-olefin copolymer at 190° C. at an frequency of 100 radians/second.

In embodiments of this disclosure, the unimodal polyethylene/α-olefin copolymer has a viscosity (V_{0.1}) at 190 C at a frequency of 0.1 radians/second of 120,000 to 170,000 pascal-seconds. In some embodiments, the viscosity (V_{0.1}) at 190° C. at a frequency of 0.1 radians/second of 129,000 to 157,000 pascal-seconds. In one or more embodiments, the unimodal polyethylene/α-olefin copolymer has a viscosity (V_{0.1}) at 190° C. at a frequency of 0.1 radians/second of 130,000 to 140,000 pascal-seconds.

In embodiments of this disclosure, the unimodal ethylene/α-olefin copolymer has a molecular weight distribution (MWD), as calculated by the weight average molecular weight (Mw) divided by the number-average molecular number (Mn), is from 27 to 32. In some embodiments, the unimodal ethylene/α-olefin copolymer has a molecular weight distribution of 28 to 31.

In one or more embodiments, the unimodal ethylene/α-olefin polymer may have a weight average molecular weight of greater than 340,000 g/mol. In some embodiments, the weight average molecular weight is from 340,000 to 440,000g/mol, 350,000 to 440,00 g/mol, or 360,000 to 420,000 g/mol.

In embodiments of this disclosure, the unimodal ethylene/α-olefin copolymer has a GPC_{abs} molecular weight distribution (GPC_{abs} MWD), as calculated by the GPC_{abs} weight average molecular weight (Mw) divided by the GPC_{abs} number-average molecular number (Mn), is from 24 to 29. In some embodiments, the unimodal ethylene/α-olefin copolymer has a GPC_{abs} molecular weight distribution of 25 to 28.

In one or more embodiments, the unimodal ethylene/α-olefin polymer may have a GPC_{abs} weight average molecular weight of greater than 310,000 g/mol. In some embodiments, the GPC_{abs} weight average molecular weight is from 310,000 to 410,000g/mol, 320,000 to 410,00 g/mol, or 320,000 to 390,000 g/mol. In one or more embodiments, the unimodal ethylene/α-olefin polymer may have a GPC_{abs} number average molecular weight from 9,000 to 15,000 g/mol. In some embodiments, the GPC_{abs} number average molecular weight is from 10,000 to 14,000 g/mol.

In various embodiments, the unimodal ethylene/α-olefin copolymer has an environmental stress crack resistance of greater than 1000.

In various embodiments, the melt strength of the unimodal ethylene/α-olefin polymer of this disclosure may be greater than 45 cN to 80 cN (Rheotens device, 190° C., 2.4 mm/s², 120 mm from the die exit to the center of the wheels, extrusion rate of 38.2 s⁻¹, capillary die of 30 mm length, 2 mm diameter and 180° entrance angle). The high melt strength allows for better processability than other ethylene/α-olefin polymers having a lowing melt strength. The improved processability property means that the parison is more stable during the fabrication process, and thus less susceptible to sagging.

In some embodiments, the melt strength of the unimodal ethylene/α-olefin polymer of this disclosure may be from 46 to 70 cN. In one or more embodiments, the melt strength of the unimodal ethylene/α-olefin polymer of this disclosure may be from 47 to 60 cN.

In one or more embodiments, the strain hardening modulus of the unimodal ethylene/α-olefin polymer of this disclosure may be from 41 to 45 MPa.

In embodiments, the ethylene/α-olefin polymer produced, for example homopolymers and/or interpolymers (including copolymers) of ethylene and, optionally, one or more comonomers may include at least 50 mole percent (mol. %) monomer units derived from ethylene. For example, the polyethylene may include at least 60 mol. %, at least 70 mol. %, at least 80 mol. %, or at least 90 mol. % monomer units derived from ethylene. In embodiments, the polyethylene includes from 50 mol. % to 100 mol. % monomer units derived from ethylene. For example, the polyethylene may include from 50 mol. % to 90 mol. %, from 50 mol. % to 80 mol. %, from 50 mol. % to 70 mol. %, from 50 mol. % to 60 mol. %, from 60 mol. % to 100 mol. %, from 60 mol. % to 90 mol. %, from 60 mol. % to 80 mol. %, from 60 mol. % to 70 mol. %, from 70 mol. % to 100 mol. %, from 70 mol. % to 90 mol. %, from 70 mol. % to 80 mol. %, from 80 mol. % to 100 mol. %, from 80 mol. % to 90 mol. %, or from 90 mol. % to 100 mol. % monomer units derived from ethylene.

In embodiments, the ethylene/α-olefin polymer produced includes at least 90 mol. % monomer units derived from ethylene. For example, the polyethylene may include at least 93 mol. %, at least 96 mol. %, at least 97 mol. %, or at least 99 mol. % monomer units derived from ethylene. In embodiments, the polyethylene includes from 90 mol. % to 100 mol. % monomer units derived from ethylene. For example, the polyethylene may include from 90 mol. % to 99.5 mol. %, from 90 mol. % to 99 mol. %, from 90 mol. % to 97 mol. %, from 90 mol. % to 96 mol. %, from 90 mol. % to 93 mol. %, from 93 mol. % to 100 mol. %, from 93 mol. % to 99.5 mol. %, from 93 mol. % to 99 mol. %, from 93 mol. % to 97 mol. %, from 93 mol. % to 96 mol. %, from 96 mol. % to 100 mol. %, from 96 mol. % to 99.5 mol. %, from 96 mol. % to 99 mol. %, from 96 mol. % to 97 mol. %, from 97 mol. % to 100 mol. %, from 97 mol. % to 99.5 mol. %, from 97 mol. % to 99 mol. %, from 99 mol. % to 100 mol. %, from 99 mol. % to 99.5 mol. %, or from 99.5 mol. % to 100 mol. % monomer units derived from ethylene.

In embodiments, the ethylene/α-olefin polymer produced includes less than 50 mol. % monomer units derived from an additional «-olefin. For example, the polyethylene may include less than 40 mol %, less than 30 mol. %, less than 20 mol. % or less than 10 mol. % monomer units derived from an additional α-olefin. In embodiments, the polyethylene includes from 0 mol. % to 50 mol. % monomer units derived from an additional α-olefin. For example, the polyethylene may include from 0 mol. % to 40 mol. %, from 0 mol. % to 30 mol. %, from 0 mol. % to 20 mol. %, from 0 mol. % to 10 mol. %, from 0 mol. % to 5 mol. %, from 0 mol. % to 1 mol. %, from 1 mol. % to 50 mol. %, from 1 mol. % to 40 mol. %, from 1 mol. % to 30 mol. %, from 1 mol. % to 20 mol. %, from 1 mol. % to 10 mol. %, from 1 mol. % to 5 mol. %, from 5 mol. % to 50 mol. %, from 5 mol. % to 40 mol. %, from 5 mol. % to 30 mol. %, from 5 mol. % to 20 mol. %, from 5 mol. % to 10 mol. %, from 10 mol. % to 50 mol. %, from 10 mol. % to 40 mol. %, from 10 mol. % to 30 mol. %, from 10 mol. % to 20 mol. %, from 20 mol. % to 50 mol. %, from 20 mol. % to 40 mol. %, from 20 mol. % to 30 mol. %, from 30 mol. % to 50 mol. %, from 30 mol. % to 40 mol. %, or from 40 mol. % to 50 mol. % monomer units derived from an additional α-olefin.

In embodiments, the unimodal ethylene/α-olefin polymer produced further includes one or more additives. Such additives include, but are not limited to, antistatic agents, color enhancers, dyes, lubricants, pigments, primary antioxidants, secondary antioxidants, processing aids, ultraviolet (UV) stabilizers, and combinations of these. The polyethylene may include any amounts of additives. In embodiments, the produced polyethylene further includes fillers, which may include, but are not limited to, organic or inorganic fillers, such as, for example, calcium carbonate, talc, or Mg(OH)₂.

The produced unimodal ethylene/α-olefin polymer may be used in a wide variety of products and end-use applications. The produced polyethylene may also be blended and/or co-extruded with any other polymer. Non-limiting examples of other polymers include linear low-density polyethylene (LLDPE), elastomers, plastomers, high pressure low density polyethylene, high density polyethylene, polypropylenes, and the like. The produced polyethylene and blends including the produced polyethylene may be used to produce blow-molded components or products, among various other end uses. The produced polyethylene and blends including the produced polyethylene may be useful in forming operations such as film, sheet, and fiber extrusion and co-extrusion as well as blow molding, injection molding and rotary molding. Films may include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, and membranes in food-contact and non-food contact applications. Fibers may include melt spinning, solution spinning and melt blown fiber operations for use in woven or non-woven form to make filters, diaper fabrics, medical garments, and geotextiles. Extruded articles may include medical tubing, wire and cable coatings, pipe, geomembranes, and pond liners. Molded articles may include single and multi-layered constructions in the form of bottles, L-ring drums, tanks, large hollow articles, rigid food containers and toys.

Some embodiments of this disclosure include a process of blow molding a polyethylene/α-olefin copolymer. The process for blow molding may include melting the unimodal polyethylene/α-olefin copolymer according to this disclosure; and forming an article via blow molding.

### Test Methods

Polymerization Activity: Unless indicated otherwise, all polymerization activities (also referred to as productivities) presently disclosed were determined as a ratio of polymer produced to the amount of catalyst added to the reactor and are reported in grams of polymer per grams of catalyst per hour (gPE/gcat/hr).

Comonomer Content: Unless indicated otherwise, all comonomer contents (i.e., the amount of comonomer incorporated into a polymer) presently disclosed were determined by rapid FT-IR spectroscopy on dissolved polymer in a Gel Permeation Chromatography (GPC) measurement and are reported in weight percent (wt. %). The comonomer content of a polymer can be determined with respect to polymer molecular weight by use of an infrared detector, such as an IR5 detector, in a GPC measurement, as described in Lee et al., Toward absolute chemical composition distribution measurement of polyolefins by high-temperature liquid chromatography hyphenated with infrared absorbance and light scattering detectors, 86 ANAL. CHEM. 8649 (2014).

Uptake Ratio: Unless indicated otherwise, all uptake ratios presently disclosed were determined as a ratio of an amount of monomer units derived from a comonomer (e.g., a (C₃-C₁₂)α-olefin comonomer) to an amount of monomer units derived from ethylene.

Density: Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Flow Index or High Load Melt Index (HLMI) I₂₁ Test Method: use ASTM D1238-13, Standard Test Method for Melt Flow Rates of Thermoplastics by Extrusion Platometer, using conditions of 190° C./21.6 kilograms (kg). Report results in units of grams eluted per 10 minutes (g/10 min.).

Melt Index (“I₂”) Test Method: for ethylene-based (co)polymer is measured according to ASTM D1238-13, using conditions of 190° C./2.16 kg, formerly known as “Condition E”.

Melt Index I₅ (“I₅”) Test Method: use ASTM D1238-13, using conditions of 190° C./5.0 kg. Report results in units of grams eluted per 10 minutes (g/10 min.).

Melt Flow Ratio MFR2: (“I₂₁/I₂”) Test Method: calculated by dividing the value from the HLMI I₂₁ Test Method by the value from the Melt Index I₂ Test Method.

Melt Flow Ratio MFR5: (“I₂₁/I₅”) Test Method: calculated by dividing the value from the HLMI I₂₁ Test Method by the value from the Melt Index I₅ Test Method.

2% Secant Modulus Test Method: measured according to ASTM D790-10, Procedure B, Standard Test Methods for Flexural Properties of Unreinforced and Reinforced Plastics and Electrical Insulating Materials. Report results in megapascals (MPa). 1,000.0 pounds per square inch (psi)=6.8948 MPa.

Dynamic Rheological Analysis: Dynamic oscillatory shear measurements are conducted over a range of 0.1 rad s-1 to 100 rad s-1 at a temperature of 190° C. and 10% strain with stainless steel parallel plates of 25 mm diameter on the strain controlled rheometer ARES/ARES-G2 by TA Instruments, to determine the melt flow properties of the ethylene-based polymers. V0.1 and V100 are the viscosities at 0.1 and 100 rad s-1, respectively (with V0.1/V100 being a measure of shear thinning characteristics). Complex Shear Viscosity Test Method: determine rheological properties at 0.1 and 100 radians/second (rad/s) in a nitrogen environment at 190° C. and a strain of 10% in an ARES-G2 (TA Instruments) rheometer oven that is preheated for at least 30 minutes at 190° C. Place the disk prepared by the Compression Molded Plaque Preparation Method between two “25 mm” parallel plates in the oven. Slowly reduce the gap between the “25 mm” parallel plates to 2.0 mm. Allow the sample to remain for exactly 5 minutes at these conditions. Open the oven, and carefully trim excess sample from around the edge of the plates. Close the oven. Allow an additional 5-minute delay to allow for temperature equilibrium. Then determine the complex shear viscosity via a small amplitude, oscillatory shear, according to an increasing frequency sweep from 0.1 to 100 rad/s to obtain the complex viscosities at 0.1 rad/s and 100 rad/s. Define the shear viscosity ratio (SVR) as the ratio of the complex shear viscosity in pascal-seconds (Pa·s) at 0.1 rad/s to the complex shear viscosity in pascal-seconds (Pa·s) at 100 rad/s.

Melt Strength Test Method: Carried out Rheotens (Göttfert) melt strength experiments isothermally at 190° C. Produced a melt by a Göttfert Rheotester 2000 capillary rheometer, or Rheograph 25 capillary rheometer, paired with a Rheotens model 71.97, with a flat, 30/2 die at a shear rate of 38.2 s-1. Filled the barrel of the rheometer in less than one minute. Waited 10 minutes to ensure proper melting. Varied take-up speed of the Rheotens wheels with a constant acceleration of 2.4 mm/s². The die used for testing has a diameter of 2 mm, length of 30 mm and entry angle of 180 degrees. Load a test sample in pellet form into capillary barrel and allow it to melt and equilibrate at the testing temperature (190° C.) for 10 minutes to give a molten test sample. Then use the piston inside the barrel to apply a steady force on the molten test sample to achieve an apparent wall shear rate of 38.16 s⁻¹, and extrude the melt through the die with an exit velocity of approximately 9.7 mm/s. Located 100 mm below the die exit, guide the extrudate through wheel pairs (spaced 0.4 mm apart) of the rheometer, which both accelerate at a constant rate of 2.4 mm/s² and measure the extrudate's response to the applied extensional force. Display the test results as plots of force with respect to Rheotens wheel speed using the RtensEvaluations2007 Excel software. For analysis, the force at which fracture occurs in the melt is referred to as the melt strength of the material and the corresponding Rheotens wheel speed at fracture is considered the drawability limit. Monitored tension in the drawn strand over time until the strand broke. Calculated melt strength by averaging the flat range of tension.

Strain Hardening Modulus Test Method: The ISO 18488 standard is followed to determine strain hardening modulus (“SHM”). Resin pellets are compression molded into sheets of 0.3 mm thickness following molding conditions described in Table 1 of the ISO 18488 standard. After molding, the sheets are conditioned at 120° C. for one hour followed by controlled cooling at a rate of 2° C./min to room temperature. Five tensile bars (dog bone shaped) are punched out of the compression molded sheets. The tensile test is conducted in a temperature chamber at 80° C. Each specimen is conditioned for at least 30 minutes in the temperature chamber prior to starting the test. The test specimen is clamped top and bottom and a pre-load of 0.4 MPa with a speed of 5 mm/min is applied. During the test, the load and the elongation sustained by the specimen are measured. The test specimen is extended at a constant speed of 20 mm/min and data point are collected from a draw ratio (λ) of 8.0 until λ=12.0 or breakage. As specified in ISO 18488, the plot of true stress vs. draw ratio is used to calculate the slope between a draw ratio of 8.0 and 12.0. If failure occurred before a draw ratio of 12.0, then the draw ratio corresponding to the failure strain is considered as upper limit for the slope calculation. If failure occurred before a draw ratio of 8.0, then the test is considered invalid.

Charpy Impact Strength Test Method: the Charpy impact strength testing is done at negative 40° C. according to ISO 179, Plastics—Determination of Charpy Impact Properties. 80 millimeters (mm)×10 mm×4 mm (L×W×T) specimens that are cut and machined from a 4 mm compression molded plaque that has been cooled at 5° C./minute. The specimens are notched on their long sides in the thickness direction to a depth of 2 mm using a notcher device with a 22.5 degree half-angle and a 0.25 radius curvature at its tip. Specimens are cooled in a cold box for 1 hour then removed and tested in less than 5 seconds. The impact tester meets the specification described in ISO 179. The test is typically performed over a range of temperatures spanning about 0° C., −15° C., −20° C., and −40° C. For the present method, the results reported are those for −40° C. temperature. Results are reported in units of kilojoules per square meter (kJ/m²).

Environmental Stress Crack Resistance (ESCR) Test Method: ESCR measurements are conducted according to ASTM D1693-15, Standard Test Method for Environmental Stress-Cracking of Ethylene Plastics, Method B and ESCR (10% IGEPAL CO-630, F50) is the number of hours to failure of a bent, notched, compression-molded test specimen that is immersed in a solution of 10 weight percent IGEPAL CO-630 in water at a temperature of 50° C. IGEPAL CO-630 is an ethoxylated branched-nonylphenol of structural formula 4-(branched-C₉H₁₉)-phenyl-[OCH2CH2]ₙ-OH, wherein subscript n is a number such that the branched ethoxylated nonylphenol has a number-average molecular weight of about 619 grams/mole

The above-described ESCR Test Method is used herein. For a more precise indication of stress-cracking resistance than that characterized by the above ESCR measured according to ASTM D1693-15, use instead Equivalent Stress-Cracking Resistance (EqSCR) determined by notched constant ligament stress (nCLS).

Equivalent Stress-Cracking Resistance (EqSCR) Test Method: EqSCR is determined by notched constant ligament stress (nCLS): Notched Constant Ligament Stress (nCLS) values at 600 psi actual pressure are based on ASTM F2136. The nCLS values were used as a more precise indication of performance than the Environmental Stress Crack Resistance (ESCR) based on ASTM D1693-15.

Conventional Gel Permeation Chromatography Test Method (GPCconv): The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 165° Celsius and the column compartment and detectors were set at 155° Celsius. The columns used were 4 TOSOH TSKgel GMHHR-H (30) HT 30-micron particle size, mixed pore size columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. Individually prepared polystyrene standards of 10,000,000 and 15,000,000 g/mol, both from Agilent Technologies, were also prepared, at 0.5 and 0.3 mg/mL respectively. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.3992 and B is equal to 1.0.

A third order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 12,000 for the 4 TOSOH TSKgel GMHHR-H (30) HT 30-micron particle size, mixed pore size columns.

Samples were prepared in a semi-automatic manner with the PolymerChar “Instrument Control” Software, wherein the samples were weight-targeted at 1 mg/ml, and the solvent (contained 200 ppm BHT) was added to a pre nitrogen-sparged septa-capped vial, via the PolymerChar high temperature autosampler. The samples were dissolved for 3 hours at 165° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( {RV}_{( FM Calibrated )} / {RV}_{( FM Sample )} ) \qquad ( EQ 5 )$$

Absolute Gel Permeation Chromatography Test Method (GPC_{abs}): Triple Detector GPC (TDGPC): For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are be calculated according to equations 8-10 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ 8 )$$

$$Mw ( Abs ) = \frac{{\sum }^{i} {IR}_{i} \times {M}_{{Absolute}_{i}}}{{\sum }^{i} {IR}_{i}} \qquad ( EQ 9 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )}$$

### EXAMPLES

### Production of Catalyst

Catalysts employed in the Inventive Examples 1, specifically those using C35300MSF chromium on silica support, were prepared on a commercial scale as follows. About 698.5 kg (1540 pounds) of a porous silica support containing about 5 weight percent chromium acetate (Grade C35300MSF chromium on silica, produced by PQ Corporation), which amounts to about 1 weight percent Cr content, having a particle size of about 90 microns and a surface area of about 500 square meters per gram was charged to a fluidized bed heating vessel. There it was heated slowly at a rate of about 50° C. per hour under dry nitrogen up to 200° C. and held at that temperature for about 4 hours. Next it was heated slowly at a rate of about 50° C. per hour under dry nitrogen up to 450° C. and held at that temperature for about 2 hours. The nitrogen stream was then replaced with a stream of dry air and the catalyst composition was heated slowly at a rate of about 50° C. per hour to 600° C. where it was activated for about 6 hours. The activated catalyst was then cooled with dry air (at ambient temperature) to about 300° C. and further cooled from 300° C. to room temperature with dry nitrogen (at ambient temperature). The resulting cooled powder was stored under nitrogen atmosphere until treated with a reducing agent as described below.

In a typical chromium oxide catalyst reduction, the catalyst was placed in a vertical catalyst blender with a helical ribbon agitator under an inert atmosphere. Degassed and dried hexane or isopentane solvent was added to adequately suspend the supported catalyst. For catalysts using C35300MSF starting material in the Examples, about 7.1 liters of solvent were charged per kilogram (0.89 gallons per pound) of support. DEALE, available from Nouryon, and obtained as a 25 wt % solution in isopentane or hexane, was then added to the surface of the catalyst slurry at a selected rate over a selected time period to obtain a selected molar ratio of DEALE/Cr. The mixture was agitated at a selected agitation rate at a temperature of approximately 45° C. during the selected addition time. The mixture was further agitated at a controlled rate for about 2 hours. Then the solvent was substantially removed by drying at a jacket temperature of approximately 70° C. and slightly above atmospheric pressure for about 18 hours. The resulting dry, free flowing powder was then stored under nitrogen until used.

Catalysts employed in the Comparative Examples 1, specifically those using a silyl chromate compound on silica support, were prepared on a commercial scale as follows. About 1116 kg (2460 pounds) of porous silica support (Grade Sylopol 955 chromium on silica, produced by Davison Catalyst division of W. R. Grace and Co.), having a particle size of about 40 microns and a surface area of about 300 square meters per gram was charged to a fluidized bed heating vessel. There it was heated slowly at a rate of about 100° C. per hour under dry nitrogen up to 325° C. and the nitrogen stream was then replaced with a stream of dry air. The silica support was heated slowly at a rate of about 100° C. per hour to 600° C. where it was activated for about 1.5 hours. The calcined support was then cooled with dry air (at ambient temperature) to about 300° C. and further cooled from 300° C. to room temperature with dry nitrogen (at ambient temperature). The resulting cooled powder was stored under nitrogen atmosphere until treated with a chromium compound and then a reducing agent as described below.

In supporting the silyl chromate compound on the silica, the support was placed in a vertical catalyst blender with a helical ribbon agitator under an inert atmosphere. For catalysts in the Examples, about 5.8 liters of isopentane solvent were charged per kilogram (0.70 gallons per pound) of silica. The resulting mixture was stirred and heated to about 45° C. Then 3.15 kilograms of bis (triphenylsilyl) chromate was charged for every 100 kilograms of silica. This was stirred at about 45° C. for 10 hours. A 25 wt % solution of DEALE in isopentane was then added to the surface of the catalyst slurry at a selected rate over a selected time period to obtain a selected molar ratio of DEALE/Cr. The mixture was agitated at a selected agitation rate at a temperature of approximately 45° C. during the selected addition time. The mixture was further agitated at a selected rate for about 2 hours. Then the solvent was substantially removed by drying at a jacket temperature of approximately 75° C. and slightly above atmospheric pressure for about 24 hours. The resulting dry, free flowing powder was then stored under nitrogen until used.

### Production of Polyethylene

ACCLAIM™ K-100 was utilized for polymerization. For the polymerization, a gas phase fluidized bed reactor was used which had a 0.57 m internal diameter and 4.0 m bed height and a fluidized bed composed of polymer granules. Fluidization gas was passed through the bed at a velocity of 1.8 to 2.2 ft/s. The fluidization gas exited the top of the reactor and passed through a recycle gas compressor and heat exchanger before re-entering the reactor below a distribution grid. A constant fluidized bed temperature was maintained by continuously adjusting the temperature of water on the shell side of a shell-and-tube heat exchanger. Gaseous feed streams of ethylene (monomer), nitrogen and hydrogen together with 1-hexene (comonomer) were introduced into a recycle gas line. The reactor was operated at a total pressure of approximately 2068 kPa gauge and vented to a flare to control pressure. Individual flow rates of ethylene, nitrogen, hydrogen and 1-hexene were adjusted to maintain desired targets. Concentrations of all gasses were measured using an on-line gas chromatograph. The catalyst was fed semi-continuously at a rate to achieve a targeted polymer production rate in the range of 50 to 60 lbs/hour. The fluidized bed was maintained at constant height by withdrawing a portion of the bed at a rate equal to the rate of formation of product. Product was removed semi-continuously via a series of valves into a fixed volume chamber. A nitrogen purge removed a significant portion of entrained and dissolved hydrocarbons in the fixed volume chamber. The product was further treated with a small stream of humidified nitrogen to deactivate any trace quantities of residual catalyst and/or cocatalyst. Polymerization conditions and/or product properties are reported in Table 2.

The reaction conditions used for each run are reported in Table 2. The properties of the poly(ethylene-co-1-hexene) copolymer produced by each run are reported in Tables 3, and 4.

TABLE 1
Reaction conditions

| | | Polyethylene | Polyethylene |
|---|---|---|---|
| Part # | | Composition 1 | Composition 2 |
| Reaction Configuration | | Single | Single |
| Reactor Temperature | (° C.) | 100.5 | 99.0 |
| Reactor Pressure | (psig) | 350 | 350 |
| Recycle Gas Velocity | (ft/sec) | 1.8 | 2.62 |
| Ethylene Partial Pressure * | (psi) | 200 | 230 |
| H2/C2 Ratio ** | (mol/mol) | 0.005 | 0.051 |
| C6/C2 Ratio *** | (mol/mol) | 0.0080 | 0.0009 |
| O2 Addback | (ppbv) | 22 | 40 |
| Residence Time | Hrs | 2.2 | 2.9 |

TABLE 2

| Sample | Density | I₂₁ | | GPC_{conv} | GPC_{conv} | GPC_{conv} | GPC_{conv} |
|---|---|---|---|---|---|---|---|
| Description | g/cc | dg/min | I₂₁/I₅ | Mw | Mn | Mz | Mw/Mn |
| Inventive | 0.9463 | 6.58 | 27.5 | 357,683 | 12,117 | 3,726,822 | 29.5 |
| Example | | | | | | | |
| Comparative | 0.9465 | 6.21 | 29.7 | 317,569 | 12,715 | 3,457,219 | 25.0 |
| C1 | | | | | | | |

TABLE 3

| | −40 C. | Strain | | 2% Sec. | | | Melt | | |
|---|---|---|---|---|---|---|---|---|---|
| Sample | Charpy | Hardening | ESCR | Mod. | | V_{0.1} | Strength | T₁₀₀₀ | SCBD/ |
| Description | kJ/m² | MPa | hr | MPa | V_{0.1}/V₁₀₀ | Pa s | cN | sec | 1000 C. |
| Inventive | 7.4 | 43 | >1000 | 786 | 56.3 | 130,739 | 48 | 8.9 | 3.2 |
| Example | | | | | | | | | |
| Comp. C1 | 5.4 | 38 | >1000 | 779 | 54.7 | 122,356 | 45 | 9.3 | 2.4 |

TABLE 4
Absolute GPC Data

| Sample Description | Mn | Mw | Mz | Mw/Mn |
|---|---|---|---|---|
| GPC Method | GPC_{abs} | GPC_{abs} | GPC_{abs} | GPC_{abs} |
| Inventive Example | 12,446 | 329,491 | 2,332,534 | 26.5 |
| Comparative C1 | 12,729 | 291,025 | 2,017,481 | 22.9 |

As previously described, the processability is often inversely related to the end-use performance of a IBC, meaning that the more processable the resin is, the less capable the resin is at with standing end-use factors (such as stress and chemical exposure). Therefore, the processability results and the end-use performance results of the Inventive Example were compared to the processability results and the end-use performance results of the Comparative C1 resin. Comparative C1 resin is a commercial product used to make intermediate bulk containers.

The processability parameters used to test the Inventive Example and the Comparative C1 resin included melt strength, melt flow (I₂₁), melt flow ratio (I₂₁/I₅), viscosity ratio (V_{0.01}/V₁₀₀), and T₁₀₀₀ results. The Inventive Example when compared to the Comparative C1 resin had a slightly higher melt strength (48 cN compared to the Comp. C1 of 45 cN), similar melt flow and melt flow ratio, similar viscosity ratio, and similar T₁₀₀₀ results. Based on these results, the Inventive example resin is very processable.

Additionally, the Inventive example had very good end-use performance results. To study the end-use performance results, the resin of the Inventive example was subjected to the Charpy Test at negative 40 degrees; the secant modulus Test at 2%; and the strain hardening modulus. In each of these tests, the Inventive Example had an increase in performance when compared to the Comparative C1 resin.

1. A process for producing unimodal ethylene/α-olefin copolymer, the process comprising contacting ethylene and, optionally, one or more (C₃-C₁₂)α-olefin comonomers with a catalyst system in a gas-phase polymerization reactor, wherein the catalyst system comprises a chromium-based catalyst;
wherein the unimodal ethylene copolymer comprises:
a density from 0.942 g/cm³ to 0.950 g/cm³ according to ASTM D792-13;
a flow index (I₂₁) from 5.5 to 7.5 dg/min, when measured according to ASTM D1238 at 190° C. and a 21.6 kg load;
a strain hardening modulus of 40 to 50 MPa; and
a GPC_{abs} molecular weight distribution (MWD), as measured by the weight average molecular weight (Mw) divided by the molecular number (Mn) (M_{w}/Mₙ), that is from 24 to 29 as determined by an absolute gel permeation chromatography method (GPC_{abs}).

2. The process of claim 1, wherein:
the density is in the range of 0.943-0.949 g/cm³; and
the melt flow index (I₂₁) is from 5.5 to 7.2 dg/min.

3. The process of claim 1, wherein the unimodal ethylene/α-olefin copolymer has a melt viscosity ratio (V_{0.1}/V₁₀₀) at 190° C. from 50 to 70, where V_{0.1} is the viscosity of the unimodal ethylene/α-olefin copolymer at 190° C. at a frequency of 0.1 radians/second, and V₁₀₀ is the viscosity of the unimodal ethylene/α-olefin copolymer at 190° C. at a frequency of 100 radians/second.

4. The process of claim 1, wherein the GPC_{abs} molecular weight distribution (MWD) is from 25 to 28.

5. The process of claim 1, wherein the unimodal ethylene/α-olefin copolymer has a viscosity (V_{0.1}) at 190° C. at a frequency of 0.1 radians/second greater than or equal to 130,000 pascal-seconds.

6. The process of claim 1, wherein the (C₃-C₁₂)α-olefin comonomer is 1-hexene.

7. An unimodal ethylene/α-olefin copolymer comprising polymerized units derived from ethylene, wherein the unimodal ethylene/α-olefin copolymer comprises:
a density from 0.942 g/cm³ to 0.950 g/cm³ according to ASTM D792-13;
a flow index (I₂₁) from 5.5 to 7.5 dg/min, when measured according to ASTM D1238 at 190° C. and a 21.6 kg load;
Charpy impact strength of 6.5 to 8.5 kilojoules per meter square (kJ/m²), measured at −40° C. according to ISO 179;
a stain hardening modulus of 41 to 45 MPa; and
a GPC_{abs} molecular weight distribution (MWD), as measured by the weight average molecular weight (Mw) divided by the GPC_{abs} molecular number (Mn) (M_{w}/Mₙ), that is from 24 to 29 as determined by an absolute gel permeation chromatography method (GPC_{abs}).

8. The unimodal ethylene/α-olefin copolymer of claim 7, wherein the density is in the range of 0.943-0.949 g/cm³.

9. The unimodal ethylene/α-olefin copolymer of claim 7, wherein the melt flow index (I₂₁) is from 5.5 to 7.2 dg/min.

10. The unimodal ethylene/α-olefin copolymer of claim 7, wherein the unimodal ethylene/α-olefin copolymer has a melt viscosity ratio (V_{0.1}/V₁₀₀) at 190° C. is from 50 to 70, where V_{0.1} is the viscosity of the unimodal ethylene/α-olefin copolymer at 190° C. at a frequency of 0.1 radians/second, and V₁₀₀ is the viscosity of the unimodal ethylene/α-olefin copolymer at 190° C. at a frequency of 100 radians/second.

11. The unimodal ethylene/α-olefin copolymer of claim 7, wherein the GPC_{abs} molecular weight distribution (MWD) (M_{w}/Mₙ), is from 25 to 28.

12. The unimodal ethylene/α-olefin copolymer of claim 7, wherein the unimodal ethylene/α-olefin further comprises a environmental stress cracking resistance of greater than 1000 hours.

13. An article comprising the unimodal ethylene/α-olefin copolymer of claim 7.

14. A process of blow molding a unimodal ethylene/α-olefin copolymer into a blow-molded article, the process comprising:
melting the unimodal ethylene/α-olefin copolymer according to claim 7 to produce a melt thereof;
extruding the melt into a mold to form a shape; and
injecting a gas into the mold so as to create a cavity within the shape.
